(19) United States
(12) Patent Application Publication
(10) Pub. No.: US 2018/0068005 A1
(43) Pub. Date: Mar. 8, 2018

(54) DISTRIBUTED COMPUTATION OF PERCENTILE STATISTICS FOR MULTIDIMENSIONAL DATA SETS

(71) Applicant: LinkedIn Corporation, Mountain View, CA (US)

(72) Inventors: Srinivas S. Vemuri, Santa Clara, CA (US); Maneesh Varshney, San Jose, CA (US); Krishna P. Puttaswamy Naga, Sunnyvale, CA (US)

(73) Assignee: LinkedIn Corporation, Mountain View, CA (US)

(21) Appl. No.: 15/258,189

(22) Filed: Sep. 7, 2016

(51) Int. Cl. G06F 17/30

(52) U.S. Cl. CPC G06F 17/30592; G06F 17/30598

(57) ABSTRACT

The disclosed embodiments provide a system for processing data. During operation, the system obtains a set of partitions containing a set of records, wherein the records include a set of values for a measure and a set of dimensions associated with the values. Next, the system reorganizes the records across the partitions by performing a distributed sort of the records by the measure. For each dimensional subset in the records, the system counts occurrences of the dimensional subset in each of the partitions and groups values of the counted occurrences by the dimensional subset so that the values reside in a single processing node. The system uses the values to identify one or more locations in the partitions for calculating a statistic for the dimensional subset and uses the location(s) to calculate the statistic. Finally, the system outputs the statistic in response to a query containing the dimensional subset.

### BACKGROUND

### Field

The disclosed embodiments relate to data analysis. More specifically, the disclosed embodiments relate to techniques for performing distributed computation of percentile statistics for multidimensional data sets.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, querying of large data sets may result in high server latency and/or server timeouts (e.g., during processing of requests for aggregated data) and/or the crashing of client-side applications such as web browsers (e.g., due to high data volume).

Consequently, big data analytics may be facilitated by mechanisms for efficiently and/or effectively collecting, storing, managing, querying, analyzing, and/or visualizing large data sets.

### BRIEF DESCRIPTION OF THE FIGURES

FIG. 1 shows a schematic of a system in accordance with the disclosed embodiments.

FIG. 2 shows the distributed computation of statistics for a multidimensional data set in accordance with the disclosed embodiments.

FIG. 3 shows a flowchart illustrating the processing of data in accordance with the disclosed embodiments.

FIG. 4 shows a flowchart illustrating the process of calculating a statistic for a dimensional subset in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

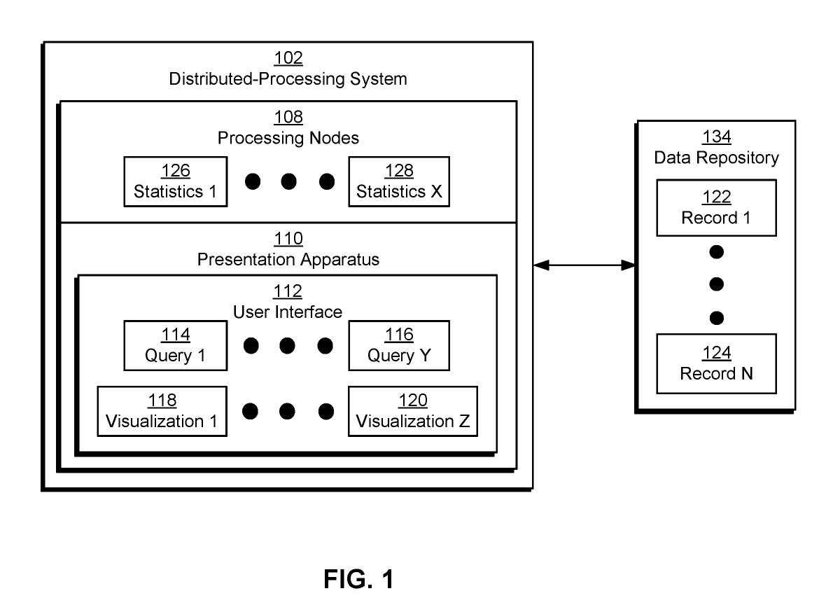

The disclosed embodiments provide a method, apparatus, and system for processing data. As shown in FIG. 1, the system may be a distributed-processing system 102 that retrieves a set of records (e.g., record 1 122, record n 124) from a data repository 134 and generates a set of statistics (e.g., statistics 1 126, statistics x 128) associated with the records.

Records in data repository 134 may form a multidimensional data set such as an Online Analytical Processing (OLAP) cube. Each record may include a measure such as a page load time, service response time, sale amount, profit, expense, page views, clicks, temperature, and/or other measurable or quantifiable value in the data set. The records may also include one or more dimensions that categorize, group, and/or label the corresponding measures. For example, a record may include a measure representing a sales volume and a set of dimensions indicating the location, product name, and month associated with the sales volume.

In one or more embodiments, a set of processing nodes 108 in distributed-processing system 102 is used to calculate statistics for various dimensional subsets of the multidimensional data set represented by the records. The processing nodes may be represented by a cluster, grid, or other collection of processors, computer systems, and/or other processing resources. In turn, the processing nodes may calculate sums, averages, medians, percentiles, and/or other statistics from measures and different combinations of dimensions in the data set.

More specifically, each dimensional subset may include a specified or unspecified value for each dimension in the data set. Continuing with the previous example, dimensional subsets of a multidimensional data set containing dimensions of location, product name, and month may include all possible values of all three dimensions, all possible values of two of the dimensions and a specific value for the remaining dimension (i.e., any location and product name with a specific month, any location and month with a specific product name, any product name and month with a specific location), all possible values of one dimension and specific values for the other two dimensions (i.e., a specific location and specific product name with any month, a specific location and specific month with any product name, a specific product name and specific month with any location), and specific values for all three dimensions. Thus, a sum for a dimensional subset may be calculated by summing the sales volume measure for all records matching the dimensional subset, an average for the dimensional subset may be calculated by averaging the sales volume measure for the records, and a percentile for the dimensional subset may be obtained from the frequency distribution of the measure in the records.

After the statistics are calculated for some or all dimensional subsets of the multidimensional data set, the statistics may be stored in data repository 134 and/or a separate repository for subsequent retrieval and use. A presentation apparatus 110 in distributed-processing system 102 may retrieve the stored data and display visualizations (e.g., visualization 1 118, visualization z 120) and/or other output representing the statistics in response to queries (e.g., query 1 114, query y 116) of the records and/or statistics. For example, a user may interact with a user interface 112 (e.g., graphical user interface (GUI), command-line interface (CLI), etc.) provided by the presentation apparatus to specify one or more measures, dimensions, and/or statistics associated with the multidimensional data set. The presentation apparatus may obtain data matching the specified values from the data repository and display tables, spreadsheets, line charts, bar charts, histograms, pie charts, and/or other representations of the data in the user interface.

Presentation apparatus 110 may also allow the user to specify one or more filters associated with the displayed data, such as values, ranges of values, and/or flags associated with the measure, statistics, and/or dimensions. In turn, visualizations and/or other output shown in user interface 112 may be updated based on the specified filters. Consequently, distributed-processing system 102 may facilitate the discovery of relationships, patterns, and/or trends in the data; gaining of insights from the data; and/or the guidance of decisions and/or actions related to the data.

In one or more embodiments, distributed-processing system 102 includes functionality to reduce latency, workload, scalability issues, and inefficiency in calculating statistics for various dimensional subsets (e.g., OLAP cubes) of multidimensional data sets in data repository 134. As described in further detail below, such performance improvements may be achieved over conventional techniques by averting replication of data between processing steps and balancing workload across the processing nodes and steps.

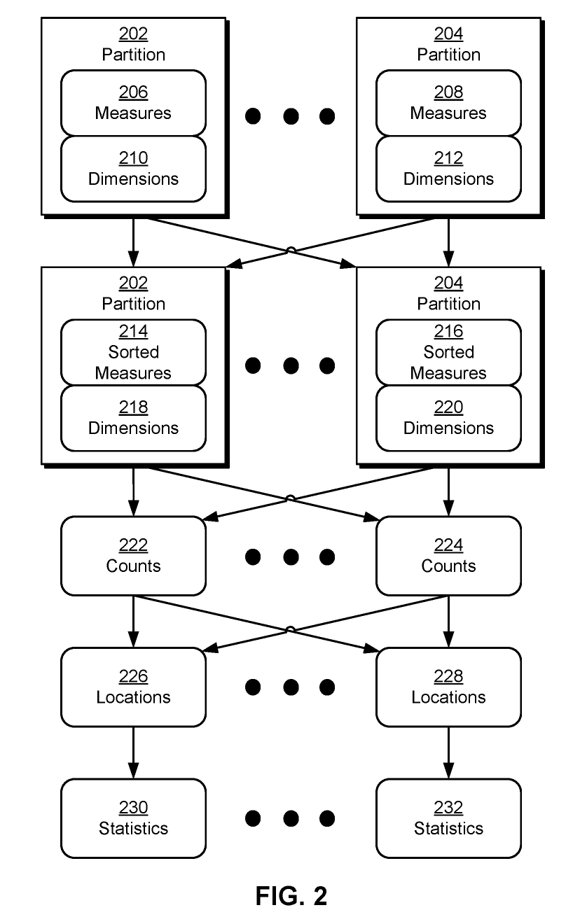

As shown in FIG. 2, the processing steps may be represented by multiple stages of processing, with the output from one stage used as input for the next stage. First, the processing nodes may retrieve a number of partitions 202-204 of records from data repository 134. The partitions may reside on multiple disks, servers, storage nodes, and/or other storage mechanisms. For example, a partitioning scheme may distribute the partitions across the storage mechanisms so that the storage mechanisms contain substantially the same total number of records or amount of data from the data repository. Alternatively, the partitioning scheme may distribute the partitions unevenly across the storage mechanisms to accommodate differences in computational and/or storage resources The partitions may then be loaded into memory on the corresponding processing nodes so that each processing node contains one or more partitions.

Records in each partition 202-204 may include one or more measures 206-208 and one or more dimensions 210-212 associated with the measures. For example, the records may include a total sales as a measure and associated dimensions of location and month. In other words, the measure may represent the total number of units sold of a product or service, the location may represent a city, state, and/or region in which the sales were made, and the month may represent a time period over which the sales were made.

Next, the processing nodes may perform a distributed sort of the records in partitions 202-204 by the values of measures 206-208. For example, the processing nodes may use a parallel quicksort, parallel mergesort, bitonic mergesort, and/or other distributed sorting technique to shuffle and/or reorganize the records across the partitions so that records in each partition are locally sorted by ascending order of measure values and the partitions are sorted in increasing order of measure values. After the distributed sort is complete, records in each partition may include a set of sorted measures 214-216, as well as the associated dimensions 218-220.

The processing nodes may then use the sorted records to generate a set of counts 222-224, with each count indicating the number of occurrences of a given dimensional subset in a given partition. To generate the counts, each processing node may iterate through the sorted records in the corresponding partition and count the number of times each dimensional subset is found in records in the partition. For example, the dimensional subset representing all possible values of dimensions 218-220 may have a count equal to the number of records in the partition. Dimensional subsets that specify values for one or more dimensions may have a count equal to the number of records in the partition that contain the specified values. The count for each dimensional subset may also be recorded with an identifier for the corresponding partition.

After the counts are generated, the processing nodes may perform a distributed shuffle of the counts so that all counts for a given dimensional subset across all partitions are grouped for processing by a single processing node. In addition, the distribution of the grouped counts may be balanced across the processing nodes to reduce skew in the workload of the processing nodes. For example, a hash value of each dimensional subset may be used to both group the counts by the dimensional subset and balance the distribution of the grouped counts across the processing nodes (e.g., by assigning different groups counts to different processing nodes in a substantially balanced fashion). The grouped counts may then be converted into tabular entries so that each entry includes a column representing a given dimensional subset and a number of additional columns indicating the number of occurrences of the dimensional subset in different partitions.

The processing nodes may then use the grouped counts 222-224 to generate a set of locations 226-228 of records in partitions 202-204 that can be used to calculate one or more statistics (e.g., statistics 230-232) for the corresponding dimensional subsets. For example, the processing nodes may use the grouped counts residing on the processing node and the sorted records in the partitions to identify one or more partitions containing one or more measure values used to calculate the statistic for a given dimensional subset, as well as the positions of one or more records in the partition storing the value(s). An exemplary use of grouped counts to identify measure values for calculating a median statistic for a dimensional subset may include the following:
partition 1: 100 records
partition 2: 20 records
partition 3: 30 records
partition 4: 60 records
   The total number of records for the dimensional subset is 100+20+30+60, or 210. Thus, the median value for the dimensional subset may be calculated using the 104^{th} and 106^{th} values, which can be found in partition 2.

The processing nodes may store the identified partitions, positions, and/or other attributes associated with the locations in one or more additional records in memory. After the locations of records used to calculate the statistic are generated for all relevant dimensional subsets, the processing nodes may perform a distributed shuffle of the locations so that all locations of records used to calculate the statistic in a given partition are grouped under the processing node containing the partition.

Finally, locations 226-228 are used to calculate one or more statistics 230-232 for all relevant dimensional subsets of records in partitions 202-204. For example, each processing node may load the corresponding partition or partitions of sorted records into memory, if the partition(s) are not already in memory on the processing node. Next, the processing node may use locally stored locations 226-228 of the sorted records in the partition(s) to output measure values for calculating a statistic for the corresponding dimensional subsets. The processing nodes may then use a hash of the dimensional subsets and/or another mechanism to shuffle the outputted measure values so that all measure values used to calculate a statistic for a given dimensional subset reside in a single processing node. Finally, the processing node may use the grouped measure values to calculate the statistic for the dimensional subset.

The distributed computation of statistic 230-232 described above may be illustrated using an exemplary multidimensional data set that is split between two partitions (e.g., partitions 202-204). The first partition contains the following three records:

| | | |
|---|---|---|
| CA | January | 100 |
| CA | February | 120 |
| NY | January | 40 |

The second partition contains the following the records:

| | | |
|---|---|---|
| CA | February | 200 |
| NY | January | 80 |
| NY | February | 400 |

The first column of the data set represents a state dimension (e.g., “CA” or “NY”), the second column of the data set represents a month dimension (e.g., “Jan” or “Feb”), and the third column of the data set represents a positive integer measure associated with the state and month (e.g., a total sales in the state over the month).

Next, the records in the partitions are sorted by increasing measure value. After the sort is complete, records in the first partition contain the following ordering:

| | | |
|---|---|---|
| NY | January | 40 |
| NY | January | 80 |
| CA | January | 100 |

Similarly, records in the second partition contain the following ordering:

| | | |
|---|---|---|
| CA | February | 120 |
| CA | February | 200 |
| NY | February | 400 |

Thus, sorted records in the first partition include the lowest three measure values sort in ascending order, and sorted records in the second partition include the highest three measure values sorted in ascending order.

After the records are sorted across the partitions, a count of occurrences of each dimensional subset in the data set is generated for each partition. The count is stored with the dimensional subset and an identifier for the corresponding partition to produce the counted occurrences of dimensional subsets in the first partition:

| | | | |
|---|---|---|---|
| * | * | 3 | 1 |
| CA | * | 1 | 1 |
| NY | * | 2 | 1 |
| * | January | 3 | 1 |
| CA | January | 1 | 1 |
| NY | January | 2 | 1 |

Along the same lines, the counted occurrences of dimensional subsets in the second partition include the following:

| | | | |
|---|---|---|---|
| * | * | 3 | 2 |
| CA | * | 2 | 2 |
| NY | * | 1 | 2 |
| * | February | 3 | 2 |
| CA | February | 2 | 2 |
| NY | February | 1 | 2 |

Within the counted occurrences, the first column represents a value of the state dimension, which may be a specific value (e.g., “CA” or “NY”) or unspecified (e.g., “*”). The second column represents a value of the month dimension, which may be a specific value (e.g., “Jan” or “Feb”) or unspecified (e.g., “*”). The third column represents the number of occurrences of the state and month dimensions in a given partition, and the fourth column contains an identifier for the partition (e.g., 1 or 2).

The counted occurrences are subsequently shuffled between processing nodes and converted into tabular entries that group the counted occurrences by dimensional subset. As mentioned above, a hash value of the dimensional subset and/or another mechanism may be used to group the counted occurrences and distribute the counted occurrences between two processing nodes in a balanced way. A first set of tabular entries residing on a first processing node includes the following grouped counts (e.g., grouped counts 222-224):

| | | | |
|---|---|---|---|
| * | * | 3 | 3 |
| NY | * | 2 | 1 |
| * | February | 0 | 3 |
| CA | February | 0 | 2 |
| NY | February | 0 | 1 |

A second set of tabular entries residing on a second processing node include the following grouped counts:

| | | | |
|---|---|---|---|
| CA | * | 1 | 2 |
| * | January | 3 | 0 |
| CA | January | 1 | 0 |
| NY | January | 2 | 0 |

In the tabular entries, the first two columns represent the state and month dimensions, respectively, of a dimensional subset. The third column represents the number of occurrences of the dimensional subset in the first partition, and the fourth column represents the number of occurrences of the dimensional subset in the second partition.

The grouped counts and sorted records are used to identify locations of “middle” measure values in the frequency distribution of the corresponding dimensional subsets, which may be used to calculate median measure values for the dimensional subsets. More specifically, the first set of tabular entries are used to generate the following locations:

| | | | |
|---|---|---|---|
| * | * | 1 | 3 |
| * | * | 2 | 1 |
| NY | * | 1 | 2 |
| * | February | 2 | 2 |
| CA | February | 2 | 1 |
| CA | February | 2 | 2 |
| NY | February | 2 | 3 |

The second set of tabular entries are used to generate the following locations:

| | | | |
|---|---|---|---|
| CA | * | 2 | 1 |
| * | January | 1 | 2 |
| CA | January | 1 | 3 |
| NY | January | 1 | 1 |
| NY | January | 1 | 2 |

In the above locations, the first two columns represent the state and month dimensions, respectively, of a dimensional subset. The third column contains an identifier for a partition, and the fourth column indicates the position of a record in the partition that is used to calculate the median value of the measure for the dimensional subset. If multiple locations exist for a given dimensional subset, the locations may be averaged to obtain the median for the dimensional subset.

The locations are then shuffled across the processing nodes so that a given set of locations resides in the same processing node as the corresponding partition. Thus, a set of locations of records used to calculate the median measure value in the first partition includes the following:

| | | |
|---|---|---|
| * | * | 3 |
| NY | * | 2 |
| * | January | 2 |
| NY | January | 1, 2 |
| CA | January | 3 |

A set of locations used to calculate the median measure value in the second partition includes the following:

| | | |
|---|---|---|
| * | * | 1 |
| * | February | 2 |
| CA | February | 1, 2 |
| NY | February | 3 |
| CA | * | 1 |

In the above locations, the first two columns represent the state and month dimensions, respectively, of a dimensional subset. The third column indicates one or more positions of records in the corresponding partition for calculating the median value of the measure for the dimensional subset. Because the locations are already grouped by partition, the column identifying the partition may be removed from the shuffled locations.

The locations in the first partition are used to output the corresponding values of the measure in the first partition:

| | | |
|---|---|---|
| * | * | 100 |
| NY | * | 80 |
| * | January | 80 |
| NY | January | 40, 80 |
| CA | January | 100 |

Similarly, the locations in the second partition are used to output the corresponding values of the measure in the second partition:

| | | |
|---|---|---|
| * | * | 120 |
| * | February | 200 |
| CA | February | 120, 200 |
| NY | February | 400 |
| CA | * | 120 |

In the above output, the first two columns represent the state and month dimensions, respectively, of the dimensional subset. The third column contains one or more values of the measure for calculating the median value of the measure for the dimensional subset.

The outputted measure values are further grouped by dimensional subset to produce the following first set of grouped measure values on the first processing node:

| | | |
|---|---|---|
| * | * | 100, 120 |
| NY | * | 80 |
| * | January | 80 |
| NY | January | 40, 80 |
| CA | January | 100 |

The following second set of grouped measure values is also stored on the second processing node:

| | | |
|---|---|---|
| * | February | 200 |
| CA | February | 120, 200 |
| NY | February | 400 |
| CA | * | 120 |

Finally, the grouped measure values are used by the processing nodes to calculate the median measure value for the corresponding dimensional subsets, resulting in the following output:

| | | |
|---|---|---|
| * | * | 110 |
| NY | * | 80 |
| * | January | 80 |
| NY | January | 60 |
| CA | January | 100 |
| * | February | 200 |
| CA | February | 160 |
| NY | February | 400 |
| CA | * | 120 |

More specifically, a single measure value for a corresponding dimensional subset may be used as the median value of the measure for the dimensional subset, while two values grouped under the same dimensional subset may be averaged to produce the median value of the measure for the dimensional subset.

The technique described above may be adapted to statistics other than medians. For example, a 70^{th} percentile statistic for a dimensional subset may be obtained by using the grouped counts to identify, in the partitions, one or more locations of measures in the dimensional subset that are higher than 70% of other measures in the dimensional subset, and then using measure values at the location(s) to calculate the statistic.

On the other hand, without the benefit of the computation methods provided herein, a conventional technique for calculating the median value of the measures in the exemplary data set would initially expand the records in the first partition into all possible dimensional subsets associated with dimensions found in the records:

| | | |
|---|---|---|
| * | * | 100 |
| * | * | 120 |
| * | * | 40 |
| CA | * | 100 |
| CA | * | 120 |
| NY | * | 40 |
| * | January | 100 |
| * | January | 40 |
| * | February | 120 |
| CA | January | 100 |
| CA | February | 120 |
| NY | January | 40 |

Along the same lines, the conventional technique would expand records in the second partition into all possible dimensional subsets associated with dimensions found in the records:

| | | |
|---|---|---|
| * | * | 200 |
| * | * | 80 |
| * | * | 400 |
| CA | * | 200 |
| NY | * | 180 |
| NY | * | 400 |
| * | January | 80 |
| * | February | 200 |
| * | February | 400 |
| CA | February | 200 |
| NY | January | 80 |
| NY | February | 400 |

Measure values in the expanded records would then be grouped by dimensional subset, and the median would be computed from the grouped measure values. Because the conventional technique expands the initial set of records in an exponential fashion, such calculation fails to scale with large data sets. Moreover, the expanded records may result in high skew in the workload of different processing nodes and a general increase in the workload of the processing nodes, thereby reducing the performance and/or efficiency benefits of parallel computation in the processing nodes.

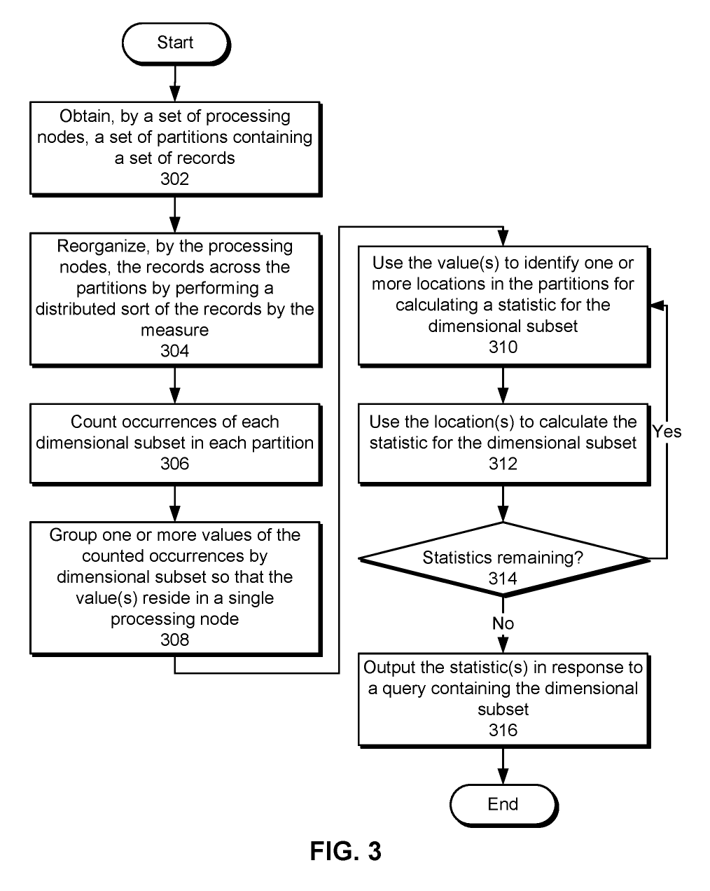

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of partitions containing a set of records is obtained by a set of processing nodes (operation 302). The records may include a set of values for a measure and a set of dimensions associated with the values. For example, the records may include a numeric measure related to product sales and dimensions describing the locations, time periods, products, and/or other attributes associated with the sales. In another example, the records may include a numeric measure related to a page load time, a service response time, and/or another performance metric and dimensions describing web pages, websites, data centers, applications, resources, time periods, and/or other attributes associated with the performance metric. The records may be distributed substantially equally among multiple partitions, and the partitions may be stored in a set of storage nodes (e.g., in a distributed filesystem and/or distributed database).

Next, the processing nodes are used to reorganize the records across the partitions by performing a distributed sort of the records by the measure (operation 304). For example, one or more distributed sorting techniques may be used to shuffle the records among the processing nodes until records in each partition are locally sorted by ascending order of measure values and the partitions are sorted in increasing order of measure values.

Occurrences of each dimensional subset in each partition are counted (operation 306) by the processing nodes, and one or more values of the counted occurrences are grouped by dimensional subset so that the value(s) reside in a single node (operation 308). For example, a hash value of each dimensional subset may be used to both group the counts by the dimensional subset and balance the distribution of counted occurrences for all dimensional subsets in the records across the set of partitions.

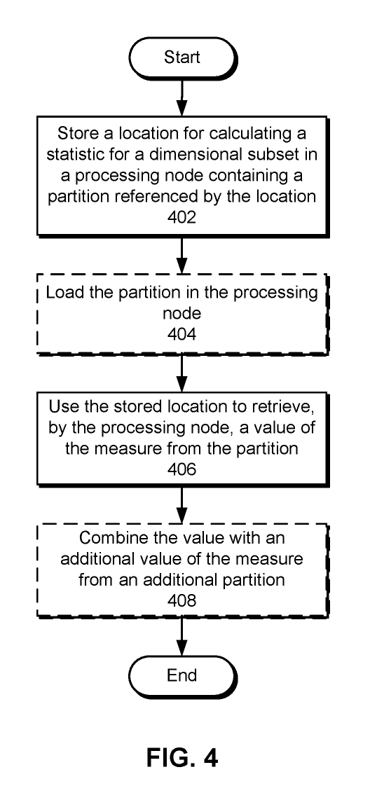

The grouped value(s) are used to identify one or more locations in the partitions for calculating a statistic for the dimensional subset (operation 310). For example, groupings of counted occurrences for each dimensional subset may be used by the processing nodes to identify one or more positions of sorted records in the partitions that contain measure values for calculating a percentile and/or other statistic for the measure within the dimensional subset. The identified location(s) are then used to calculate the statistic for the dimensional subset (operation 312), as described in further detail below with respect to FIG. 4.

Operations 310-312 may be repeated for remaining statistics (operation 314) to be calculated for the measure. For example, a median value for the measure may be calculated from one or two “middle” values of the measure in the sorted records for a given dimensional subset, and a 25^{th} percentile value for the measure may be calculated from one or two values of the measure that occupy the percentile rank of 25 in the sorted records for the dimensional subset.

Finally, the statistic(s) are outputted in response to a query containing the dimensional subset (operation 316). For example, the measures, dimensions, and/or statistics may be displayed within a table, chart, or graph and/or outputted into a file, spreadsheet, and/or other format.

FIG. 4 shows a flowchart illustrating the process of calculating a statistic for a dimensional subset in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a location for calculating the statistic for the dimensional subset is stored in a processing node containing a partition referenced by the location (operation 402). The stored location may identify the partition and a position of a record in the partition. Next, the partition is optionally loaded in the processing node (operation 404). For example, the partition may be retrieved from one or more storage nodes, and a set of sorted records in the partition may be loaded in memory on the processing node.

The stored location is used to retrieve, by the processing node, a value of the measure from the partition (operation 406). For example, the processing node may iterate through a subset of sorted records containing the dimensional subset in the loaded partition until a record representing the position in the location is reached. The measure value stored in the record may then be used as the statistic, or the value may optionally be combined with an additional value of the measure from an additional partition (operation 408) to produce the statistic. For example, a single location for calculating the statistic for the dimensional subset may be used to retrieve a single measure value from the location and use the single measure value as the statistic. On the other hand, two or more locations for calculating the statistic for the dimensional subset may be used to retrieve two or more values of the measure, which are subsequently summed, averaged, or otherwise aggregated to produce the statistic.

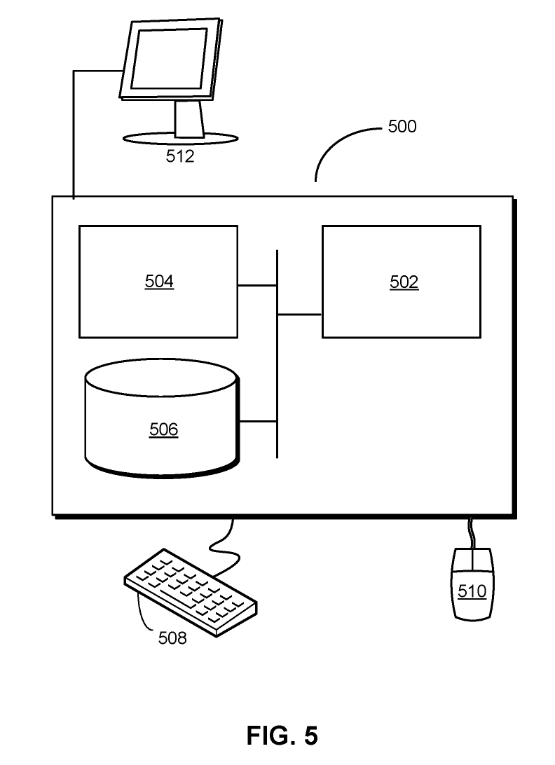

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include a set of processing nodes and a presentation apparatus, one or both of which may alternatively be termed or implemented as a module, mechanism, or other type of system component. The processing nodes may obtain a set of partitions comprising a set of records, with the records containing a set of values for a measure and a set of dimensions associated with the set of values. Next, the processing nodes may reorganize the records across the partitions by performing a distributed sort of the records by the measure. For each dimensional subset in the set of records, the processing nodes may count occurrences of the dimensional subset in each of the partitions and group one or more values of the counted occurrences by the dimensional subset so that the value(s) reside in a single node in a set of processing nodes. The processing nodes may then use the value(s) to identify one or more locations in the set of partitions for calculating a first statistic for the dimensional subset and use the location(s) to calculate the first statistic for the dimensional subset. The processing nodes may further use the value(s) to identify one or more additional locations in the set of partitions for calculating a second statistic for the dimensional subset and use the additional location(s) to calculate the second statistic for the dimensional subset. Finally, the presentation apparatus may output the first and/or second statistics in response to a query containing the dimensional subset.

In addition, one or more components of computer system 500 may be remotely located and connected to the other components over a network. Portions of the present embodiments (e.g., processing nodes, presentation apparatus, partitions, data repository, etc.) may also be located on different nodes of a distributed system that implements the embodiments. For example, the present embodiments may be implemented using a cloud computing system that performs distributed computation of statistics for a number of partitioned multidimensional data sets.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, by a set of processing nodes, a set of partitions comprising a set of records, wherein the set of records comprises a set of values for a measure and a set of dimensions associated with the set of values;
reorganizing, by the processing nodes, the records across the partitions by performing a distributed sort of the records by the measure;
for each dimensional subset in the set of records, counting occurrences of the dimensional subset in each of the partitions;
grouping one or more values of the counted occurrences by the dimensional subset so that the one or more values reside in a single processing node in the set of processing nodes;
using the one or more values to identify, by the single processing node, one or more locations in the set of partitions for calculating a first statistic for the dimensional subset;
using the one or more locations to calculate the first statistic for the dimensional subset; and
outputting the first statistic in response to a query comprising the dimensional subset.

2. The method of claim 1, wherein using the one or more locations to calculate the first statistic for the subset comprises:
for each location in the one or more locations:
storing the location in a processing node containing a partition referenced by the location; and
using the stored location to retrieve, by the processing node, a value of the measure from the partition.

3. The method of claim 2, wherein using the one or more locations to calculate the first statistic for the subset further comprises:
combining the value with an additional value of the measure from an additional partition to produce the first statistic.

4. The method of claim 2, wherein using the one or more locations to calculate the first statistic for the subset further comprises:
loading the partition in the processing node prior to retrieving the value of the measure from the partition.

5. The method of claim 1, wherein grouping the one or more values of the counted occurrences by the dimensional subset so that the one or more values reside in the single processing node in the set of processing nodes comprises:
using a hash of the dimensional subset to balance a distribution of the counted occurrences for all dimensional subsets in the records across the set of partitions.

6. The method of claim 1, further comprising:
identifying one or more additional locations in the set of partitions for calculating a second statistic for the dimensional subset; and
using the one or more additional locations to calculate the second statistic for the dimensional subset.

7. The method of claim 1, wherein the first statistic comprises a percentile.

8. The method of claim 1, wherein the one or more locations of the measures used to calculate the statistic comprise:
a partition; and
a position of a record in the partition.

9. The method of claim 1, wherein the measure is at least one of:
a page load time; and
a service response time.

10. An apparatus, comprising:
one or more processors; and
memory storing instructions that, when executed by the one or more processors, cause the apparatus to:
obtain a set of partitions comprising a set of records, wherein the set of records comprises a set of values for a measure and a set of dimensions associated with the set of values;
reorganize the records across the partitions by performing a distributed sort of the records by the measure;
for each dimensional subset in the set of records, count occurrences of the dimensional subset in each of the partitions;
group one or more values of the counted occurrences by the dimensional subset so that the one or more values reside in a single processing node in a set of processing nodes;
use the one or more values to identify one or more locations in the set of partitions for calculating a first statistic for the dimensional subset;
use the one or more locations to calculate the first statistic for the dimensional subset; and
output the first statistic in response to a query comprising the dimensional subset.

11. The apparatus of claim 10, wherein using the one or more locations to calculate the first statistic for the subset comprises:
for each location in the one or more locations:
storing the location in a processing node containing a partition referenced by the location; and
using the stored location to retrieve, by the processing node, a value of the measure from the partition.

12. The apparatus of claim 11, wherein using the one or more locations to calculate the first statistic for the subset further comprises:
combining the value with an additional value of the measure from an additional partition to produce the first statistic.

13. The apparatus of claim 10, wherein grouping the one or more values of the counted occurrences by the dimensional subset so that the one or more values reside in the single processing node in the set of processing nodes comprises:
using a hash of the dimensional subset to balance a distribution of the counted occurrences for all dimensional subsets in the records across the set of partitions.

14. The apparatus of claim 10, wherein the memory further stores instructions that, when executed by the one or more processors, cause the apparatus to:
identify one or more additional locations in the set of partitions for calculating a second statistic for the dimensional subset; and
use the one or more additional locations to calculate the second statistic for the dimensional subset.

15. The apparatus of claim 10, wherein the first statistic comprises a percentile.

16. The apparatus of claim 10, wherein the one or more locations of the measures used to calculate the statistic comprise:
a partition; and
a position of a record in the partition.

17. A system, comprising:
a processing module comprising a non-transitory computer-readable medium storing instructions that, when executed, cause the system to:
obtain a set of partitions comprising a set of records, wherein the set of records comprises a set of values for a measure and a set of dimensions associated with the set of values;
reorganize the records across the partitions by performing a distributed sort of the records by the measure;
for each dimensional subset in the set of records, count occurrences of the dimensional subset in each of the partitions;
group one or more values of the counted occurrences by the dimensional subset so that the one or more values reside in a single processing node in a set of processing nodes forming the processing module;
use the one or more values to identify one or more locations in the set of partitions for calculating a first statistic for the dimensional subset; and
use the one or more locations to calculate the first statistic for the dimensional subset; and
a management module comprising a non-transitory computer-readable medium storing instructions that, when executed, cause the system to output the first statistic in response to a query comprising the dimensional subset.

18. The system of claim 17, wherein using the one or more locations to calculate the first statistic for the subset comprises:
for each location in the one or more locations:
storing the location in a processing node containing a partition referenced by the location; and
using the stored location to retrieve, by the processing node, a value of the measure from the partition.

19. The system of claim 17, wherein grouping the one or more values of the counted occurrences by the dimensional subset so that the one or more values reside in the single node in the set of processing nodes comprises:
using a hash of the dimensional subset to balance the counted occurrences for all dimensional subsets in the records across the set of partitions.

20. The system of claim 17, wherein the non-transitory computer-readable medium of the processing module further stores instructions that, when executed, cause the system to:
identify one or more additional locations in the set of partitions for calculating a second statistic for the dimensional subset; and
use the one or more additional locations to calculate the second statistic for the dimensional subset.
